(19) United States
(12) Patent Application Publication
(10) Pub. No.: US 2024/0386497 A1
(43) Pub. Date: Nov. 21, 2024

(54) CARBON-BASED ASSETS WITH RELIABLE CARBON ACTIVITY QUANTIFICATION, CARBON ASSET-BACKED SECURITIES WITH VALUE ASSURANCE, AND MANAGEMENT OF CARBON-BASED ASSETS AND SECURITIES

(71) Applicant: AureusEarth, Inc., Austin, TX (US)

(72) Inventors: Wilfred Vencil SRUBAR, III, Boulder, CO (US); Michele Marie GRIESHABER, Austin, TX (US); Adam Dov ORENS, Denver, CO (US); Salmeron BARNES, Austin, TX (US)

(21) Appl. No.: 18/665,472

(22) Filed: May 15, 2024

Related U.S. Application Data
(60) Provisional application No. 63/466,632, filed on May 15, 2023.
(60) Provisional application No. 63/466,636, filed on May 15, 2023.
(60) Provisional application No. 63/466,684, filed on May 15, 2023.
(60) Provisional application No. 63/527,762, filed on Jul. 19, 2023.
(60) Provisional application No. 63/527,766, filed on Jul. 19, 2023.
(60) Provisional application No. 63/527,770, filed on Jul. 19, 2023.

(51) Int. Cl. G06Q 40/06; G06Q 40/12

(52) U.S. Cl. CPC G06Q 40/06; G06Q 40/12

(57) ABSTRACT

A carbon-based asset (CBA) may be created based on a carbon protocol for a building that utilizes mass timber. Provenance of the building material may be verified at each touchpoint from supplier to delivery vehicle to construction site. Authority of an entity to create a carbon easement with the building material and execute a carbon asset creation agreement (CABACA) that incorporates the carbon easement may be confirmed. The build process may be audited for compliance with the carbon protocol based on compliance of the building material data and confirmation of the authority. An audit report may be generated to indicate any flaws in the carbon protocol and/or failure in the building material or build to comply with the carbon protocol. Once it is determined that minimum criteria for eligibility to create a CBA based on at least the easement and the CABACA have been met, the CBA may be created.

### CROSS-REFERENCE TO RELATED APPLICATIONS

This application claims the benefit of U.S. Provisional Application No. 63/466,632,filed May 15, 2023, and titled “CARBON-BASED ASSETS WITH RELIABLE CARBON ACTIVITY QUANTIFICATION,” U.S. Provisional Application No. 63/527,762, filed Jul. 19,2023, and titled “CARBON-BASED ASSETS WITH RELIABLE CARBON ACTIVITY QUANTIFICATION,” U.S. Provisional Application No. 63/466,636, filed May 15, 2023, and titled “CARBON ASSET BACKED SECURITIES WITH VALUE ASSURANCE,” U.S. Provisional Application No. 63/527,766, filed Jul. 19, 2023, and titled “CARBON ASSET BACKED SECURITIES WITH VALUE ASSURANCE,” U.S. Provisional Application No. 63/466,684, filed May 15, 2023, and titled “MANAGEMENT OF CARBON-BASED ASSETS AND SECURITIES,” and U.S. Provisional Application No. 63/527,770, filed Jul. 19, 2023, and titled “MANAGEMENT OF CARBON-BASED ASSETS AND SECURITIES,” which are herein incorporated by reference in their entirety.

### BACKGROUND

In response to the need to reduce greenhouse gas (GHG) emissions, organizations of all kinds have proposed and instituted a wide variety of governance mechanisms. Organizations include government and non-government organizations as well as for-profit and not-for-profit organizations, ranging in size from large to small. Mechanisms include formal systems such as emissions trading systems and carbon taxes of various kinds to less formal systems such as internal carbon pricing and carbon offsets. This complicated landscape of organizations and mechanisms is intended to provide opportunities to mobilize resources for helpful projects, but it can be challenging to navigate. Conventional systems and methods intended to mobilize such resources have shortcomings in one or more aspects including with respect to effectiveness, efficiency, scalability, interoperability, reliability, and/or value assurance over longer time intervals.

Embodiments described herein address these and other problems as will be apparent to one of skill in the art from the figures and description.

The standard building design and construction process requires decisions regarding structural systems be made in the early stages. Architecture, engineering, and construction (AEC) firms typically follow the standard five phase building design process: Schematic Design (SD), Design Development (DD), Construction Documentation (CD), Bidding, Construction Administration. Major design decisions, such as whether the building will feature a concrete, steel, or mass timber structural system, are made early in the design process (i.e., SD or DD) when preliminary design options and cost estimates are presented to the building owner for their consideration. While some key sourcing decisions, such as whether to source sustainably harvested lumber, for example, can be made in CD, the primary decisions to build with wood versus steel or concrete are made earlier. Consequently, SD is the ideal phase for intervention to incentivize the decision to build with mass timber in lieu of steel or concrete.

Standardized documentation exists throughout the building design process, from schematic design through construction, and continues throughout building operations. Every building project is well documented through detailed construction drawings, building information models, bills of materials, building permits, certificates of occupancy, and other building and property tax records-many of which are publicly accessible.

Standardized documentation and publicly available records further support the thesis that buildings are an ideal vehicle for carbon offsetting, given the transparency and traceability of such documentation before, during, and after construction. Building material information, such as bills of materials (i.e., quantities) of materials, are reflected in drawings, building information models, purchase orders, and the building itself. Any substantial modifications to buildings require publicly accessible building permits. Information regarding ownership transfers is also legally documented and publicly available. For these reasons, buildings are an exceptional vehicle for quantifying, verifying, and assuring biogenic carbon storage in mass timber, given the richness, transparency, and verifiability of building related information before, during, and after construction.

### BRIEF DESCRIPTION OF THE DRAWINGS

The detailed description is depicted with reference to the accompanying figures, in which the left-most digit(s) of a reference number identifies the figure in which the reference number first appears. The use of the same reference numbers in different figures indicates similar or identical items.

FIG. 1 is a schematic diagram illustrating aspects of an example computer systems architecture in accordance with at least one embodiment.

FIG. 2 is a schematic diagram illustrating aspects of an example carbon-asset based registry in accordance with at least one embodiment.

FIG. 3 is a schematic diagram illustrating aspects of an example carbon-based asset data object in accordance with at least one embodiment.

FIG. 4 is a schematic diagram illustrating aspects of an example computer in accordance with at least one embodiment.

FIG. 5 depicts aspects of an example computer systems architecture in accordance with at least one embodiment.

FIG. 6 is a graph illustrating aspects of an example carbon leakage risk curve in accordance with at least one embodiment.

FIG. 7 illustrates aspects of an example CABS service in accordance with at least one embodiment.

FIG. 8 illustrates aspects of an example assurance fund service in accordance with at least one embodiment.

FIG. 9 illustrates aspects of an example CABS data object in accordance with at least one embodiment.

FIG. 10 depicts aspects of an example computer systems architecture in accordance with at least one embodiment.

FIG. 11 depicts aspects of an example carbon services gateway in accordance with at least one embodiment.

FIG. 12 is a flow diagram of an example process to create a carbon-based asset.

### DETAILED DESCRIPTION

This disclosure describes techniques for creating and maintaining carbon-based assets with reliable carbon activity quantification. Carbon-based assets can be an effective, efficient and/or flexible component of systems and methods intended to mobilize resources for controlling GHG emissions. As used herein, the term “carbon-based asset” refers to an asset that, at least in part, is associated with carbon activity. Carbon activity (sometimes called carbon-friendly activity) includes any suitable activity that: reduces or avoids GHG emissions to the atmosphere, removes GHGs from the atmosphere, and/or stores and/or sequesters GHGs apart from the atmosphere for a significant amount of time (e.g., a year, a decade, a century, a millennium).

Where carbon activity is associated with a good or service, the good or service may be associated with embodied carbon emissions avoidance or reduction (sometimes called avoided or reduced embodied carbon, avoided or reduced embodied GHG emissions, avoided or reduced embodied global warming potential, embedded carbon, or embedded carbon emissions) and/or operational carbon emissions avoidance or reduction. As will be appreciated by one of skill in the art, this description will at times use the term “carbon emissions” as an equivalent of “GHG emissions” including carbon dioxide (CO₂) emissions and non-CO₂ GHG emissions. Examples of storing and/or sequestering GHGs include biogenic or mineralized carbon storage or sequestration (sometimes called biogenic carbon, biogenic carbon storage, biogenic carbon sequestration or carbon mineralization). Examples of embodied carbon emissions avoidance or reduction include carbon-reduced concrete.

For clarity, carbon activity with respect to the built environment, in particular featuring mass timber, will be used throughout this description as an example. Considering the built environment, carbon activity may occur during a number of processes that result in an addition or modification to the built environment including during the manufacturing, transportation, installation, use, maintenance, disposal, and recycling and reuse of building materials.

### Carbon Activity Quantification

In accordance with at least one embodiment, quantifying carbon activity associated with a carbon-based asset is a significant aspect of creating the carbon-based asset. Different types of quantification procedures or procedural variations may be used, for example, corresponding to different types of carbon activity.

In accordance with at least one embodiment, quantifying carbon activity associated with a carbon-based asset may be a significant aspect of creating the carbon-based asset. Different types of quantification procedures or procedural variations may be used, for example, corresponding to different types of carbon activity. The different quantification procedures may generate quantification characterizations that vary in quality and, in particular, with respect to reliability (e.g., accuracy, precision, reproducibility, repeatability, confidence-enabling, trustworthiness and/or persuasiveness). For example, in a project that involves carbon activity in the form of avoiding harvesting timber from a forest in a particular regulatory region, it may be difficult to determine the extent to which compensatory additional harvesting of similar timber occurs in one or more different regulatory regions. Even with good monitoring of the project forest, the problem of monitoring every similar forest can introduce unreliability into the quantification characterization.

As another example, in projects that involve carbon activity in the form of embodied carbon or biogenic carbon storage in materials of a large building, it may be possible to determine the mass of the embodied carbon or biogenic carbon (e.g., in tCO₂ and/or tCO₂e) in the building with high accuracy and precision (e.g., with an error less than 5%, 2% or 1%), in a reproducible and efficiently repeatable manner with high confidence (e.g., with a confidence greater than 95%, 98% or 99%). Additionally, it can be conveniently verified that the embodied carbon or biogenic carbon remains stored within the building on timescales measured in decades and sometimes longer. Accordingly, design and choice of quantification procedures can significantly impact carbon activity quantification reliability. In accordance with at least one embodiment, reliability itself may be quantified, for example, with one or more scores, and criteria with respect to the reliability quantification may be used to determine sufficiently reliable procedures (e.g., comparison with a threshold or a vector of thresholds).

In one example calculation methodology used to determine the total number of carbon offset equivalents (tCO₂) for an individual project, the total quantity of biogenic carbon (tCO_{2,bio}) in qualified mass timber products may be calculated (see Module A below). The biogenic carbon and its storage lifetime may be converted into carbon offset equivalents according to a linear discounting approximation of the Lashof method of ton-year accounting, and subsequently adjusted to account for manufacturing emissions of the qualified mass timber products and prior issuance of forestry-based carbon offsets that may accompany the timber (see Module B below). When available, primary data from product-specific Environmental Product Declarations (EPDs) or other manufacturer-supplied product information can be used in the calculations. In the absence of such data, conservative values based on standards and industry-average data may be adopted for a conservative estimate of carbon offset equivalents.

### Module A: Calculation of Biogenic Carbon in Qualified Mass Timber Products

The calculation in Module A enumerates the total quantity of biogenic carbon (tCO_{2,bio}) in qualified mass timber products (i.e., CLT, GLT, NLT, DLT). A mass timber product qualifies for inclusion in the Module A calculation if the product is sourced from a working forest with established regenerative forestry management practices, and the product is placed within the most permanent elements of the building, namely the structure, enclosure, and/or foundation.

For each qualified mass timber product, total volume (m³) in the structure, enclosure, and/or foundation, the bulk (apparent) density of the mass timber product including the mass of wood, moisture, and adhesive (kg/m³), the adhesive content (mass %), the wood species or species combination, wood density (kg/m³), moisture content at time of installation (%), and elemental carbon per wood species or species combination (%) may be used in the Module A calculation exemplified here. An example summary of all information for each qualified mass timber product is shown in Table 1.

TABLE 1
Qualified mass timber products and required data for Module A and Module B

| | Module A | | | | | | | |
|---|---|---|---|---|---|---|---|---|
| | Volume in | | | | | | | Module B |
| | Structure, | | | | | Moisture | | A1-A5 |
| Qualified | Enclosure, | Bulk | | Wood | | Content | Elemental | Emissions |
| Mass | and/or | (Apparent) | Adhesive | Species or | Wood | (MC) at | Carbon | from EPD or |
| Timber | Foundation, | Density, | Content, m | Species | Density | Installation | Content | LCA, GWP_{A} |
| Product | V(m³) | (kg/m³) | (mass %) | Combination | (kg/m³) | (%) | (%) | (kgCO₂e/m³) |

Qualified
Mass
Timber
Product 1
Qualified
Mass
Timber
Product 2
. . .

The total quantity of biogenic carbon (tCO_{2,bio}) in all qualified mass timber products for a project can be directly computed according to the following equation:

$${t CO}_{2 , bio} = ( \frac{1}{1000} ) {\sum }_{i = 1}^{n} [ ( {V}_{i} \times {ρ}_{i} ) \times ( 1 - {m}_{a , i} ) \times {e}_{i} \times {( 1 + \frac{{MC}_{i}}{100} )}^{- 1} ( \frac{44}{12} ) ] \qquad Eq . 1$$

where:

Vᵢ=volume of each individual qualified mass timber product (m³).

ρᵢ=bulk (apparent) density (kg/m³) (including the mass of wood, water, and resin) of each individual qualified mass timber product at the installation moisture content. If the apparent density of the mass timber product is not known, but the wood species or species combination is known, a conservative value for apparent density can be estimated from the average wood density (see Table 2). If the wood species or species combination is not sufficiently known to determine the density, select a conservative value of 378, 392, or 406 kg/m³ (depending on a moisture content of 8%, 12%, or 16% at time of installation).

M_{a,i}=adhesive content (mass %) in each individual qualified mass timber product; if the mass percent of the adhesive is not known, select a conservative value equal to 1.25% for CLT and GLT and a conservative value of 0.25% for DLT. An adhesive content of 0% can be assumed for NLT, given that no adhesive is used.

MCᵢ=moisture content (MC) of each individual qualified mass timber product at time of installation. If a range is specified by the manufacturer, choose the highest value in the range; if the range is not specified, a conservative moisture content of 16% should be used in the calculation. The whole number for the percent (e.g., 16) should be used in the calculation.

eᵢ=elemental carbon content per wood species or species combination (see Table 2) that comprise each individual qualified mass timber product; if the wood species or species combination is not sufficiently known to determine density, choose a conservative value of 0.45.

n=total number of qualified mass timber products.

The multipliers 44/12 and 1/1000 account for the molar ratio of CO₂ to elemental carbon and the conversion from kilograms to metric tons, respectively.

TABLE 2
Specific gravities, densities, and percentage
of elemental carbon in common wood species.

| | Average | | | | Elemental |
|---|---|---|---|---|---|
| | Specific | Average Wood Density³⁰ | | | carbon |
| Species or Species | Gravity | 8% MC | @ 12% MC | @ 16% MC | content³¹, |
| Combination | (SG)²⁹ | (kg/m³) | (kg/m³) | (kg/m³) | e (%) |
| Douglas Fir/Larch | 0.50 | 540 | 560 | 580 | 0.46 |
| Douglas Fir/Larch (N) | 0.49 | 529 | 549 | 568 | 0.46 |
| Douglas Fir/Larch (S) | 0.46 | 497 | 515 | 534 | 0.46 |
| Hem-Fir | 0.43 | 464 | 481 | 498 | 0.47 |
| Hem-Fir (N) | 0.46 | 497 | 515 | 534 | 0.47 |
| Spruce-Pine-Fir | 0.42 | 454 | 470 | 487 | 0.47 |
| Spruce-Pine-Fir (S) | 0.36 | 389 | 403 | 418 | 0.47 |
| Southern Pine | 0.55 | 594 | 616 | 638 | 0.45 |

### Module B: Conversion of Biogenic Carbon Storage to Carbon Offset Equivalents

The calculation in Module B converts the biogenic carbon computed in Module A to carbon offset equivalents according to the linear discounting approximation of the Lashof method of ton-year accounting. According to the method, one ton of biogenic carbon (1 tCO_{2,bio}) stored for 100 years is numerically equivalent to an avoided emission equivalent to 1 tCO₂ (i.e., 1 carbon offset equivalent). For each Project, the quantity of biogenic carbon in qualified mass timber products (Module A) (tCO_{2,bio}), the storage lifetime (100 years), and the manufacturing, transport, and construction emissions (Life Cycle Stage A1-A5) (see Table 3) are required for the Module B calculation. These emissions must be subtracted to yield the net quantity of carbon offset equivalents that result from the storage of biogenic carbon in the qualified mass timber products. In addition, the total number of carbon offset equivalents must be adjusted to avoid double counting if the wood products were sourced from a working forest that received carbon offsets that included a provision for biogenic carbon stored in harvested wood products.

The total quantity of net carbon offset equivalents (tCO₂) generated by the storage of biogenic carbon in qualified mass timber products for an entire building project can be directly computed according to the following equation:

$$C OE = {t CO}_{2 , bio} \times ( \frac{{t}_{s}}{100} ) \times ( 1 - {C}_{f} ) - ( \frac{1}{1000} ) {\sum }_{i = 1}^{n} [ ( {GWP}_{A , i} \times {V}_{i} ) ] \qquad Eq . 2$$

where:
COE=total number of Carbon Offset Equivalents (tCO₂).
tCO_{2,bio}=biogenic carbon in all qualified mass timber products (tCO₂) (from Module A).
tₛ=guaranteed storage lifetime (years); for qualified building projects, a storage lifetime of 100 years should be used in the calculation.
GWP_{A,i}=manufacturing emissions (Life Cycle Stage A1-A5) (kgCO₂/m³) of each individual qualified mass timber product. Primary product-and manufacturer-specific EPD or LCA data should be used in the calculation. In the absence of LCA Stage A1-A5 information, conservative values presented in Table 3 should be used in the calculation.
Vᵢ=volume of each individual qualified mass timber product (m³).
n=total number of qualified mass timber products.
C_{f,i}=percentage of the biogenic carbon already accounted for through forestry carbon offset programs that account for the temporary storage of biogenic carbon in harvested wood products. In the absence of data, select a conservative value of 0.47.

The multiplier 1/1000 and 1/100 accounts for the conversion from kilograms to metric tons and the conversion of biogenic carbon storage time to carbon offset equivalents, respectively.

TABLE 3
Generic Life Cycle Stage A1-A3 and A5 GWP
data for use in Module B (kgCO₂/m³).

| Mass Timber Product | A1-A3 | A4 | A5 |
|---|---|---|---|
| Cross-Laminated | 150 | See Eq. 3 | 20 |
| Timber (CLT) | | | |
| Glue-Laminated | 175 | See Eq. 3 | 20 |
| Timber (GLT) | | | |
| Nail-Laminated | 150 | See Eq. 3 | 20 |
| Timber (NLT) | | | |
| Dowel-Laminated | 150 | See Eq. 3 | 20 |
| Timber (DLT) | | | |

The LCA Life Cycle Stage A4 transportation emissions may be calculated directly using the following equation:

$${GWP}_{A 4} = ρ \times ( \frac{1}{1000} ) [ ( {d}_{i} \times {GWP}_{i} ) + ( {d}_{s} \times {GWP}_{s} ) ] \qquad Eq . 3$$

where:
p=bulk (apparent) density (kg/m³) (including the mass of wood, water, and resin) of each individual qualified mass timber product at the installation moisture content. If the apparent density of the mass timber product is not known, but the wood species or species combination is known, a conservative value for apparent density can be estimated from the average wood density (see Table 2). If the wood species or species combination is not sufficiently known to determine the density, select a conservative value of 378, 392, or 406 kg/m³ (depending on a moisture content of 8%, 12%, or 16% at time of installation).

dl=transportation distance by land (km).

ds=transportation distance by sea (km).

GWPl=carbon dioxide equivalent emissions associated with shipping by heavy-duty truck over land (0.120 kgCO₂e/ton-km).

GWPs=carbon dioxide equivalent emissions associated with shipping by sea (0.04 kgCO₂e/ton-km).

### Assurance Pool

An assurance (i.e., “buffer” or “insurance”) pool can guarantee years of storage (e.g., 100). The assurance pool insures against the risk to buildings containing carbon assets, including damage from natural hazards, adaptive reuse, or early decommissioning or deconstruction. The assurance pool also facilitates mitigation of carbon leakage by replacing carbon offset equivalents associated with such buildings. In this regard, a carbon leakage event may be defined as damage or alterations that affect a certain percentage (e.g., 2:1%) of the qualified mass timber products (by volume) within a building that will significantly alter its biogenic carbon storage capacity. Projects may be subject to leakage if the stored biogenic carbon associated with qualified mass timber is released into the atmosphere prematurely, for example. Natural and human-induced events can also cause carbon leakage. Some of these events are unpredictable, like fires, earthquakes, and other natural disasters. Other leakage events are intentional, such as large-scale renovation projects and property redevelopment. After such an event, a requisite number of carbon assets in the assurance pool may be transferred to the owner of the original carbon assets to compensate for the remaining ton-years of biogenic carbon storage. In effect, the storage of one carbon asset is guaranteed for 100 years in this example.

Carbon leakage risk can be quantified for a project using an actuarial approach to determine the quantity of carbon offset equivalents that may be held in reserve in the assurance pool. Thus, the basis of the assurance pool may be a risk-based model that estimates the probability of building decommissioning or the like per year of operations. For example, the probability distributions can allow to properly characterize the deconstruction risk of a portfolio building for any year after a certificate of occupancy is issued. This risk value, along with the remaining carbon value, allows to determine the inventory of carbon offset equivalents that to be maintained in the assurance pool. Therefore, if a project experiences carbon leakage, carbon offset equivalents from the assurance pool equal to the total amount of leaked carbon can be allocated.

### Carbon Protocols

Carbon activity quantification is an aspect of a carbon protocol. As used herein, the term “carbon protocol” refers to the set of procedures used to create, and in at least some cases maintain, a carbon-based asset. Such procedures may specify data to be collected, provided and/or maintained (mandatory and optional); calculations to be performed; documentation to be collected, provided and/or maintained; standards to be used; trusted verification and/or auditing services; contracts and/or agreements to be executed; timelines and/or timings; and/or any suitable procedural aspect that supports and/or contributes to the creation and/or maintenance of a carbon-based asset.

Different carbon protocols may be used for different project types. A project type may use multiple different carbon protocols. For example, a project creating carbon-based assets based on carbon embodied in building materials may use a different carbon protocol for individual types of building material. In another example, a project creating carbon-based assets based on biogenic carbon stored in a building may use a different carbon protocol for carbon emissions avoided by the production of other types of building materials.

Continuing the building materials example, a suitable carbon protocol may specify timings and modes of interaction with an associated architectural process. For example, if the building material is mass timber and is being considered as part of the building's structural system, the carbon protocol may specify early interaction with the architectural process, such as during the schematic design (SD) and/or design development (DD) phases. The carbon protocol may specify which resources and resource providers (e.g., building material providers) are qualified under the carbon protocol and/or the procedure and/or criteria for qualifying resource providers as described elsewhere herein. The carbon protocol may specify provenance assurance measures, including but not limited to verification touchpoints, to ensure that building materials that arrive at a construction site have been sourced from a qualified resource provider, as well as measures for identifying variance in building material utilization during construction (e.g., design variation, wastage).

In accordance with at least one embodiment, the carbon protocol may specify a requirement to obtain a registered easement to the carbon rights in the building, enabling ownership transfer of those rights as part of a carbon-based asset, as well as to obtain an agreement from the builder and/or building owner to the easement (sometimes called a carbon asset creation agreement or a carbon offset creation agreement). The stored carbon thereby can gain many or all of the characteristics of real property. In accordance with at least one embodiment, the carbon protocol may specify that the associated carbon-based asset is to be registered with a qualified carbon-based asset registry.

These systems and methods may be utilized to create and/or maintain carbon-based assets with reliable carbon activity quantification. Such carbon-based assets may be sold on carbon markets. Alternatively, or in addition, suitable carbon-based assets may be leased along with an associated building or building portion. As a further alternative, or further in addition, such carbon-based assets may form the basis of a carbon-based tenant improvement (TI) and/or amenity for which the tenant and/or lessee pays a scheduled (e.g., monthly) fee to gain access to the carbon rights associated with the carbon-based asset (e.g., to use as offsets in their carbon accounting). Depending on the type of carbon-based asset, benefits related to tax credits and depreciation may also be available. For example, carbon-based assets associated with buildings may be able to take advantage of such benefits. As part of such alternatives, a carbon utility agreement may be executed between carbon-based asset owners and registry operators as an alternative to and/or in addition to the carbon asset creation agreement. Further details are described below.

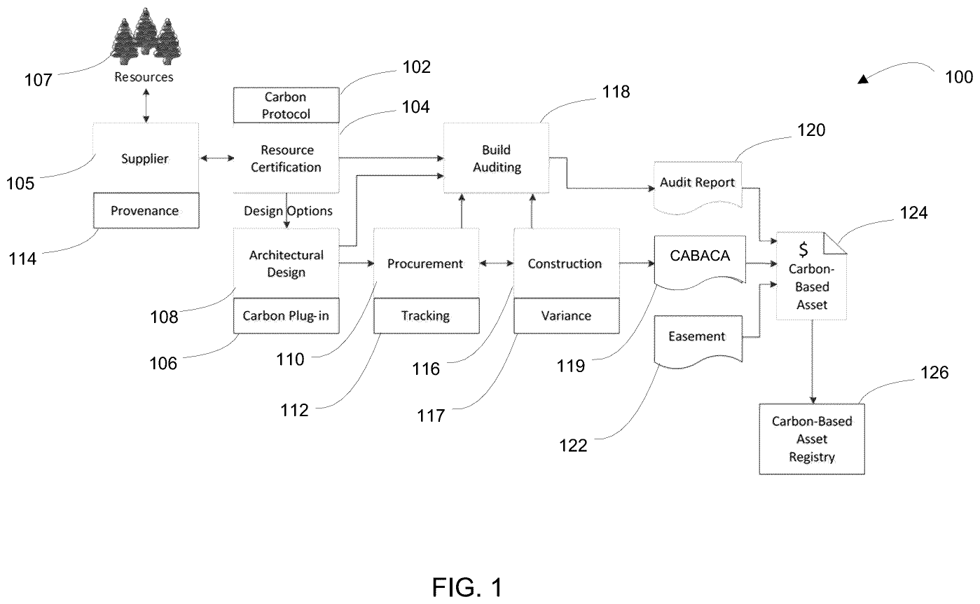

FIG. 1 depicts aspects of an example computer systems architecture 100 in accordance with at least one embodiment. The computer systems architecture 100 may include multiple computer systems that interact utilizing a data network (not shown in FIG. 1) of any suitable type including the Internet. Although the example in FIG. 1 depicts a building project using carbon activity associated with building materials to create carbon-based assets, those of skill in the art will appreciate that similar systems and methods may be applied to different project types.

A carbon protocol module 102 may maintain one or more carbon protocols in human-readable and/or computer-readable formats. The carbon protocol module 102 may provide requested carbon protocols to requesting system components. For example, a system component may subscribe to a particular set of carbon protocols offered via the carbon protocol module 102 to receive a current version of individual carbon protocols in the set as well as update versions of those carbon protocols as they become available. Should a carbon protocol be discovered to have flaws or be otherwise invalid (e.g., inadequate carbon quantification, insufficient or unreliable provenance information, or double-counting of carbon asset attribution), the carbon protocol module 102 may send a notification accordingly. Where the carbon protocol is in computer-readable format, the format may be a structured document format including meta-formats such as XML and JSON, and/or specify rules and/or criteria for complying with the carbon protocol.

A carbon protocol may include one or more technical choices or options, for example with respect to factors such as, and without limitation, parameters, tolerances, and the like to estimate or determine carbon activity quantification including explicit formulas for quantity calculation. Other choices may include identification of salient data to be provided (for example, the moisture content of mass timber at time of installation), lifetime assumptions such as how long the quantification calculations may be assumed to hold valid, and choices with respect to how carbon storage times relate to carbon emissions reduced or avoided.

A Mass Timber Building Protocol (MTBP) is an example of a carbon protocol. Mass timber (short for “massive timber”) is a building system that incorporates wood bonded together in layers for use as structural elements. Features of the MTBP may provide additional details and/or context for features described herein.

A resource certification module 104 may request one or more carbon protocols from the carbon protocol module 102 and use them to certify suppliers 105 in accordance with the carbon protocols. For example, one or more suppliers 105 of project resources 107 (e.g., building materials) with associated carbon activity may provide information to the resource certification module 104 in accordance with their corresponding carbon protocols, thereby enabling the resource certification module 104 to apply rules to the information and, given sufficient compliance with the rules, certify the suppliers. In some instances, there may be carbon protocols that specify that only certified suppliers may be utilized for projects. Some suppliers may be able to be automatically certified by the resource certification module 104 based on their level of current compliance or in the past for example, while others may require partial or full manual certification, recorded by the resource certification module 104 once the certification process is complete. The resource certification module 104 may maintain a list of certified suppliers as well as details of the resources they supply. For example, where the resources are building materials, the resource certification module 104 may maintain a database of the types of building materials offered by the suppliers as well as the architectural properties and carbon activity quantifications associated with individual types of building material.

Architectural design systems may be enhanced with a software carbon plug-in 106. For example, the carbon plug-in 106 may provide an architectural design system 108 with carbon activity details associated with building materials, such as how much carbon is sequestered in building materials, enabling real-time carbon activity estimates for incorporation into building designs during the design process as well as certified suppliers for the bill of materials for a design. In some embodiments, the information can be obtained by the carbon plug-in 106 or by the architectural design system 108 from stored tables. In accordance with at least one embodiment, the carbon plug-in 106 may provide design options including design option suggestions based at least in part on a design-in-progress. The design option suggestions may be optimized with respect to one or more carbon-related goals including maximizing embedded carbon activity and/or maximizing value of an associated carbon-based asset. In accordance with at least one embodiment, the carbon plug-in may provide referral/contact information regarding creating carbon-based assets and/or associate a carbon-based asset creation/registration process with a building design.

Once the architectural design is finalized, building materials procurement and construction may begin in accordance with the design needs, including but not limited to procuring building materials from certified suppliers (if required by the chosen carbon protocol). A procurement computer system 110 may track orders and deliveries of building materials, including building materials with associated carbon activity, using a tracking module 112. In accordance with at least one embodiment, the tracking module 112 may interact with a provenance module 114 to verify the provenance of the building materials from suppliers and hence the accuracy of carbon activity representations. In this example, the provenance module 114 may maintain multiple verification touchpoints between the supplier and the construction site, including confirming the building materials at each touchpoint. Identification of the building materials at each site may be facilitated by scan code (e.g., bar code, QR code) applied to the building materials, packaging, containers, or the like; machine learning (ML) techniques such as pattern recognition; cryptographic techniques such as identification tokens and/or tamper-resistant seals, etc. The procurement computer system 110 (and/or an independent construction computer system 116) can further track consumption of the delivered building materials as the building is constructed, and hence reveal variances from design quantities.

A build auditing computer system 118 may receive information regarding the build process from multiple computer systems and modules, and verify that the build has been conducted in accordance with the relevant carbon protocols. For example, from the resource certification module 104, the build auditing computer system 118 may receive the set of carbon protocols applicable to the build, as well as the architectural properties and carbon activity quantifications associated with the building materials. From the architectural design system 108, the build auditing computer system 118 may receive the building design and bill of materials. From the procurement computer system 110 and/or the construction computer system 116, the build auditing computer system 118 may receive building materials delivery data, building materials provenance data, building materials consumption data, building materials variance data, as well as various documents showing that the builder and/or building owner has authority to create a carbon easement and execute a carbon-based asset creation agreement (CABACA) 119. The build auditing computer system 118 may partially or fully automate the auditing process. For example, where the set of carbon protocols for the project are machine-readable, the build auditing computer system 118 may execute or otherwise carry out individual carbon protocols by verifying that the received data is in compliance with the rules and/or criteria of the carbon protocol(s). At times, such compliance may be verified at least in part by verifying that a received cryptographic token and/or electronic signature is valid.

An officially recorded easement 122 for the embodied carbon activity in the building and a carbon asset creation agreement properly executed by the builder and/or building owner, in accordance with at least one embodiment, may establish a minimum set of eligibility criteria for creation of a carbon-based asset 124 and/or registration of the carbon-based asset 124 with a carbon-based asset registry 126. The build auditing computer system 118 may also generate an audit report 120, which may be included in the minimum set of eligibility in some embodiments. In accordance with at least one embodiment, a formal audit report 121 by an independent third party may not be required. For example, some or all of the documents and data that would have been verified by the build auditing computer system 118 could be substituted and recorded in the carbon-based asset registry 126 for registry users to verify. In addition, in accordance with at least one embodiment, a formally recorded carbon activity easement 122 may not be required. For example, in some jurisdictions a formal recordation may not yet be available, and the CABACA 119 may be a sufficient substitute.

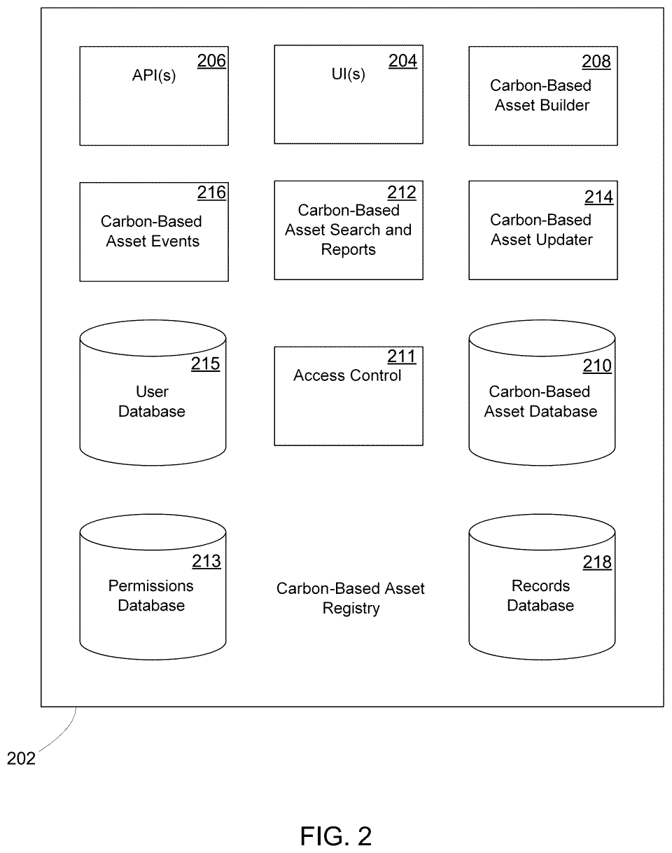

FIG. 2 illustrates aspects of an example carbon-based asset registry 202 in accordance with at least one embodiment. The carbon-based asset registry 202 may correspond to the carbon-based asset registry 126 in some embodiments. Users of the carbon-based asset registry 202 may use one or more user interfaces (UIs) 204 such as a graphical user interface (GUI) and/or one or more application programming interfaces (APIs) 206 to create, update and delete user accounts with the carbon-based asset registry 202. Users with sufficient permissions may attempt to create carbon-based assets using a carbon-based asset builder module 208.

For example, a user may use an API 206 to open a carbon-based asset building session with the carbon-based asset builder module 208. The user may further use the API 206 to supply the carbon-based asset builder module 208 with documents and data required to create a new carbon-based asset 124. For example, the user may provide the carbon-based asset builder module 208 with a CABACA document 119, an easement document 122, and/or an audit report 120. Once supplied with information sufficient to perform the carbon protocol and create a legally sufficient security contract (the CBA is a security), the user may attempt to create the carbon-based asset 124. The documents themselves need not be complete so long as they contain sufficient information to satisfy the protocol. The carbon-based asset builder module 208 may assess the provided documents and data (i.e., compare them to the rules) and determine any shortcomings. If there are shortcomings, the carbon-based asset builder module 208 may notify the user. Otherwise, the carbon-based asset builder module 208 may create a new carbon-based asset 124 and add it to a carbon-based asset database 210.

The carbon-based asset registry 202 may be partially or fully automated. In accordance with at least one embodiment, types of users may include: administrators, registry owner staff, carbon-based asset owners, users with search and/or report access, users with read-only access, guest users and/or anonymous users. Users may belong to groups, and some user types may be implemented with groups and group permissions (e.g., an administrators' group). Access control may be enforced by an access control module 211 in accordance with permissions maintained in a permissions database 213. Users and/or user profiles may be stored in a user database 215. Where processes require staff assistance (e.g., final approval of carbon-based asset creation), registry modules may manage or automate multi-user workflows to accomplish any suitable registry functionality.

By default, newly registered carbon-based assets 124 in the carbon-based asset database 210 may be available for public access. In accordance with at least one embodiment, access to carbon-based assets 124 may be restricted to private or to members of a specified group. Such viewability settings may impact users of a carbon-based asset search and reports module 212, for example, expanding or limiting the set of search results available to a user and/or to a report requested by the user. Some types of user (e.g., administrators) may be able to view carbon-based asset details even when the asset is not publicly viewable. The carbon-based asset search and reports module 212 may generate search results based on any suitable feature or set of features of carbon-based assets 124 requested. Some features may be missing from some types of carbon-based asset, for example, carbon-based assets based on embodied carbon activity associated with building materials may record an associated building location, while a different type of carbon-based asset may not be associated with a particular building location.

Once created, some or all of the data associated with the carbon-based asset 124 may be immutable. In accordance with at least one embodiment, the carbon-based asset registry 202 may act as the system of record with respect to updatable records associated with a carbon-based asset 124. For example, an owner of the carbon-based asset 124 may change, and the carbon-based asset registry 202 may reflect and be the system of record for such changes in ownership. In some embodiments, to cause a change of ownership, a current owner of a carbon-based asset 124 may use an API 206 to submit a change of ownership request to a carbon-based asset updater module 214 specifying the carbon-based asset(s) 124 to update and one or more users to become new owners of the carbon-based asset(s) 124. In accordance with at least one embodiment, the change may involve one or more cryptographic tokens issued by a third party, for example. In some instances, individual carbon-based assets 124 may be associated with an identifying cryptographic token (i.e., a token that identifies the CBA). An owner may retrieve the token and send it to the new intended owner. The new intended owner may then request a change of ownership, presenting the token as proof of ownership, enabling fully automated transactions. Other carbon-based asset properties may be updated with the carbon-based asset updater module 214. For example, it may be discovered that the status of a carbon-based asset 124 has become invalid for consideration or computation for some reason (e.g., flawed carbon protocol, retroactive decertification of a supplier, etc.) and the carbon-based asset updater module 214 can be used to update status data associated with the carbon-based asset 124 in the carbon-based asset database 210.

In some scenarios, a carbon-based asset 124 is intended to be long-lived (e.g., on the scale of years, decades, centuries and more) and during its lifetime several types of events impacting a property of the carbon-based asset may occur. For example, a disaster may occur that causes a loss of part or all of a building. As another example, the building may undergo an extensive remodel that impacts the embedded carbon activity associated with the building. A carbon-based asset events module 216 may detect or be notified of such events, notify interested users of such events, and take rules-based actions based on such events. For example, an API 206 may be used to report a loss of embedded carbon activity or a reduction in carbon activity associated with a particular building. The carbon-based asset events module 216 may detect the incoming notification and relay it to users that have indicated interest in such events (e.g., current owners). In addition, the carbon-based asset events module 216 may trigger a process to compensate for the loss (e.g., via an assurance fund as described elsewhere herein).

The carbon-based asset registry 202 and/or its component modules may be implemented with one or more computers such as server computers and/or virtual computers in a computing cloud. Alternatively, or in addition, the carbon-based asset registry 202 may be implemented, at least in part, with one or more distributed databases and/or smart contracts, for example, implemented with Ethereum blockchain technology.

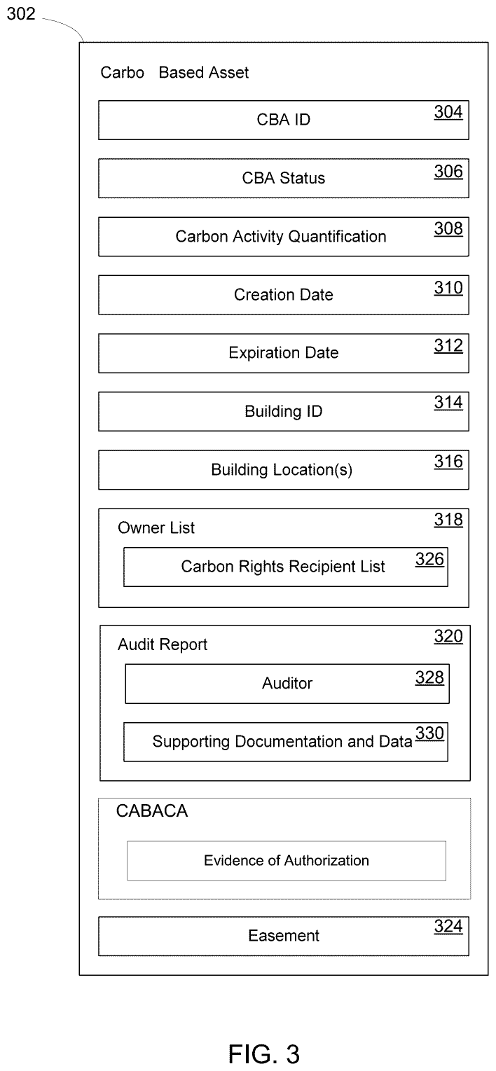

Data objects representing carbon-based assets 124 may be complex and distributed among multiple databases, for example, the carbon-based asset database 210 and a records database 218 for accompanying documents and data and associated data object history. FIG. 3 illustrates aspects of an example carbon-based asset data object 302 in accordance with at least one embodiment.

The carbon-based asset data object (CBA) 302 may include a carbon-based asset (CBA) identifier (ID) 304 such as a cryptographic identifier and/or a universally unique identifier (UUID) generated at CBA creation time. The CBA 302 may further include a CBA status 306 of one or more status fields such as a market status (e.g., active, expired, invalid) and a visibility status (e.g., public, private, restricted to a group). A carbon activity quantification 308 may characterize the carbon activity associated with the CBA 302 in one or more ways including equivalent mass of CO₂ reduced or avoided.

A creation date 310 may record when the CBA 302 was created and, by default, made available for use. In the building materials example, this will be after building construction has been completed. Further to the building materials example, buildings and building materials do not last in perpetuity and are not expected to store carbon forever. Accordingly, the CBA 302 may have an associated expiration date 312. The expiration date 312 may be set in accordance with the set of carbon protocols associated with the CBA 302 such as for 100 years from the creation date 310. Still further to the building materials example, the CBA 302 may indicate a building ID 314 and/or the associated building's location(s) 316. The building ID 314 may be issued by the CBA registry 202 in a manner similar to the CBA ID 304 itself. Alternatively, the building ID 314 may be received from a third party database of such IDs.

The CBA 302 may have an owner list 318 showing a chain of title with each successive owner of the CBA and the time interval of their ownership (and hence access to the underlying carbon rights). At times a group of registry users may be an owner. In accordance with at least one embodiment, owners may, at times, lease carbon rights associated with the CBA 302 to third parties. For example, a building owner may convey carbon rights to a tenant as part of a lease agreement and/or as a utility. The tenant would then have the right to use the carbon activity associated with the CBA 302 as part of their carbon accounting during the lease. Such delegation of rights may be recorded in a carbon rights recipient list 326, for example, as a sub-field of the owner list 318. As with the owner list 318, the time interval(s) that the lessee possessed the carbon rights may also be recorded.

The CBA 302 may further include an audit report 320, with auditor 328 and supporting documentation and data 330 as sub-fields, as well as a CABACA 322, with evidence that the registry user is authorized to execute the CABACA (e.g., a document showing title to the building).

Alternatively, or in addition, the CBA data object may include a COCA and/or carbon utility agreement. Further to the building materials example, the CBA 302 may include a document showing a formally recorded easement to the embedded carbon activity.

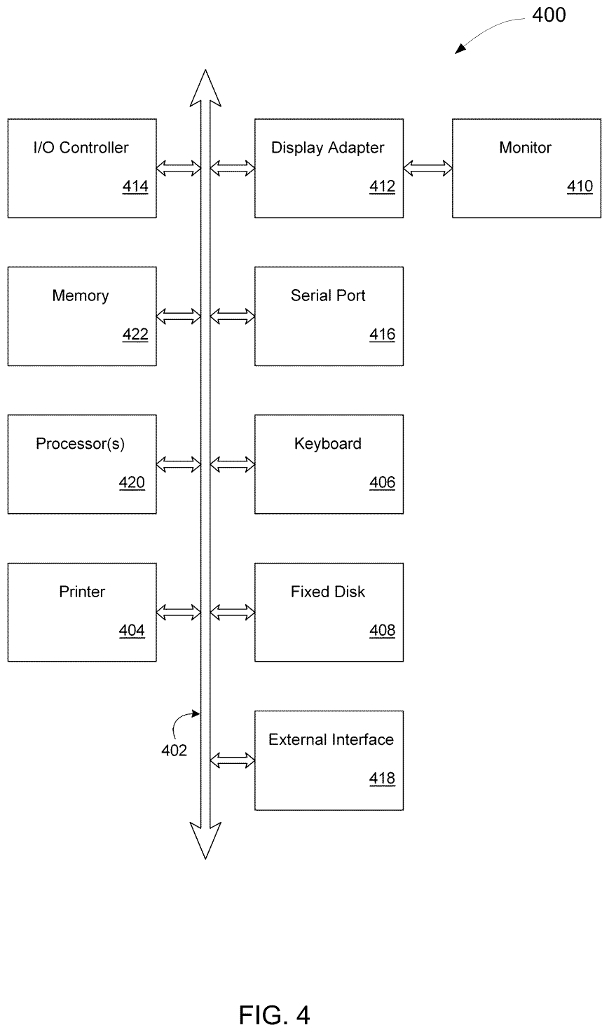

In accordance with at least some embodiments, the system, apparatus, methods, processes and/or operations for message coding may be wholly or partially implemented in the form of a set of instructions executed by one or more programmed computer processors such as a central processing unit (CPU) or microprocessor. Such processors may be incorporated in an apparatus, server, client or other computing device operated by, or in communication with, other components of the system. As an example, FIG. 4 depicts aspects of elements that may be present in a computer device and/or system 400 configured to implement a method and/or process in accordance with some embodiments of the present invention. The subsystems shown in FIG. 4 are interconnected via a system bus 402. Additional subsystems may include, without limitation, a printer 404, a keyboard 406, a fixed disk 408, and/or a monitor 410, which can be coupled to a display adapter 412. Peripherals and input/output (I/O) devices, which couple to an I/O controller 414, can be connected to the computer system in a suitable fashion, such as via a serial port 416. For example, the serial port 416 or an external interface 418 can be utilized to connect the computer device 400 to further devices and/or systems, including a wide area network such as the Internet, a mouse input device, and/or a scanner. The interconnection via the system bus 402 allows one or more processors 420 to communicate with each subsystem and to control the execution of instructions that may be stored in a system memory 422 and/or the fixed disk 408, as well as the exchange of information between subsystems. The system memory 422 and/or the fixed disk 408 may embody a tangible computer-readable medium.

This disclosure further describes techniques for creating and managing carbon asset-backed securities (CABS) with value assurance. Individual carbon-based assets (CBAs) may be purchased for their carbon rights (e.g., the right to lay claim to the carbon activity). At times, however, individual CBAs can be mismatched with investor demand. For example, CBAs can be mis-sized with respect to quantified carbon activity with individual CBA carbon activity on the order of tonnes of CO₂ equivalent (tCO₂e) while investors are looking for carbon offsets on the order of kilotonnes or even megatonnes. As another example, CBAs may provide access to carbon rights, but investors may also be looking for more conventional returns on investment.

In accordance with at least one embodiment, a carbon asset-backed security may provide an investment vehicle that incentivizes projects that can yield CBAs, but that is better matched to investor demand. While a carbon asset-backed security may be structured to suit the public securities market, in accordance with at least one embodiment, carbon asset-backed securities may instead be requested by and designed for private and/or internal investment at a company, for example, to incentivize allocation of resources and generate CBAs within the company. As used herein, the term “investor” may refer to both public and private and/or internal investors.

At times, projects that generate CBAs may be associated with a loan or other debt instrument involving repayment within a time interval. Such CBAs may be pooled to create one or more carbon asset-backed securities. Carbon asset-backed securities may provide both debt yields as well as carbon rights via pooled CBAs.

In accordance with at least one embodiment, the carbon rights associated with a carbon asset-backed security may have sufficient value to make the carbon asset-backed security competitive with conventional asset-backed securities when the carbon asset-backed security has a lower debt yield, without compromising on the quality of the underlying debt. For example, a particular pool of CBAs may have been created based on the carbon activity in certain building materials used in buildings. In addition, the buildings may be associated with construction loans. In accordance with at least one embodiment, a carbon asset-backed security may be created to provide reduced-rate financing for the construction loans based on the associated CBAs.

Financial properties of carbon asset-backed securities may be designed and/or shaped based at least in part on selection of CBAs and their associated debt instruments for the creation pool. For example, a typical CBA has a risk of carbon leakage that rises over time, which may lower the value of its associated carbon rights. The difference in such risk curves between different types of CBA can be significant. For example, CBAs associated with embodied carbon activity in building materials may have risk curves that start low and stay low since building owners are motivated to maintain buildings. As another example, carbon emissions avoided by paying a forest owner not to allow the forest to be logged may have a risk curve that ends up being significant because the initial payment may not be judged sufficient compensation over time intervals on the order of decades.

There are multiple techniques for managing such risk, but in particular a carbon asset-backed security may combine risk curves of selected CBAs to design and/or shape the resultant carbon leakage risk curve of the carbon asset-backed security. Risks related to loan yield and default risk may be managed by further selecting associated CBAs with the desired properties. Accordingly, carbon asset-backed securities can be matched and/or right-sized to investor demand based on one or more financial property goals. In accordance with at least one embodiment, CBAs may be automatically selected from an available pool to optimize (e.g., maximize or minimize) one or more designated financial goals.

In accordance with at least one embodiment, carbon leakage risk curves associated with CBAs may be mitigated and/or isolated using one or more carbon leakage assurance mechanisms. For example, an assurance fund may be established (e.g., using a captive insurance company) to mitigate and/or eliminate CBA value losses due to carbon leakage. Owners of CBAs protected by an assurance fund may receive compensation for CBA value losses due to carbon leakage. For example, an assurance fund may maintain a pool of CBAs with a total carbon activity quantification that matches an expected amount of total loss over time due to carbon leakage of a carbon asset-backed security. Such losses may be compensated for out of the assurance fund pool. The assurance fund may cover individual CBAs and/or CBA pools associated with carbon asset-backed securities. For example, an owner of a CBA associated with embodied carbon activity in a building may be subject to carbon leakage loss if the building is damaged in a disaster (e.g., flood, storm or fire damage). The owner may submit a claim for the loss to the assurance fund manager and receive compensation for the loss, for example, transfer of at least a portion of one or more CBAs with an equivalent carbon activity quantification from the assurance fund. Accordingly, such assurance funds can assure aspects of the value of carbon asset-backed securities.

These techniques may provide effective, efficient and/or scalable means for matching carbon-based investment vehicles to investor demand while providing assurance with respect to value through the creation and management of carbon asset-backed securities. Further details are described below.

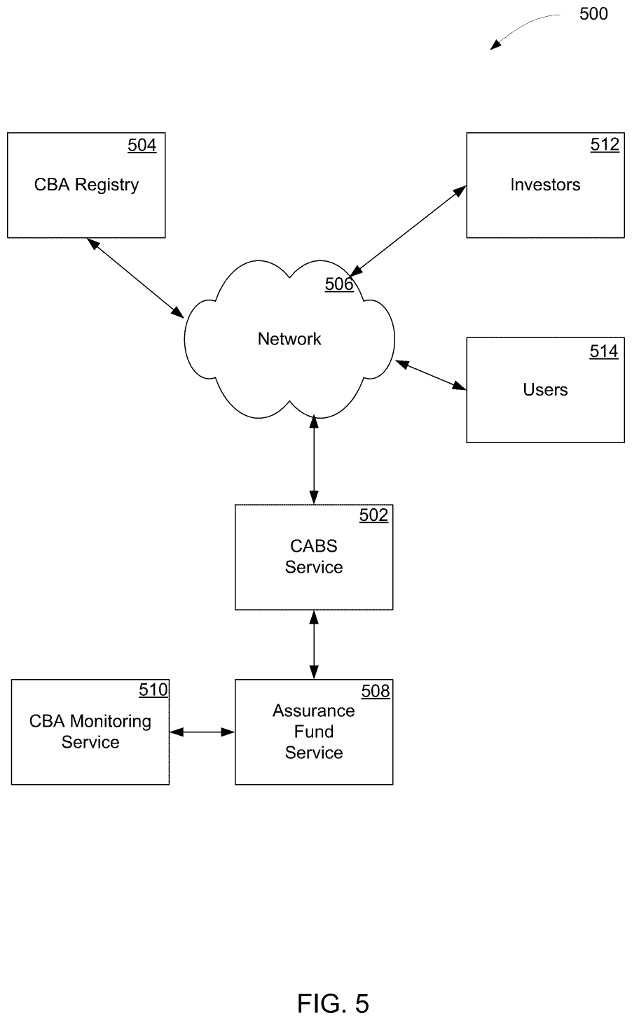

FIG. 5 depicts aspects of an example computer systems architecture 500 in accordance with at least one embodiment. A carbon asset-backed security (CABS) service 502 (e.g., software as a service) may interact with a carbon-backed asset (CBA) registry 504 over a network 506 (e.g., a data network such as the Internet) to obtain information about available CBAs with associated debt instruments (e.g., loans). Alternatively, or in addition, the CABS service 502 may interact directly with the CBA registry 504 via a private carbon services network that comprises the CABS service 502, the CBA registry 504, an assurance fund service 508, and a CBA monitoring service 510. The CABS service 502 may select from among such CBAs (e.g., purchase and/or become an owner of the CBAs) to create a pool for a new CABS. As part of CABS creation, the CABS service 502 may interact with the assurance fund service 508 to obtain carbon leakage protection for the selected CBAs, to improve one or more of the risk profiles of the new CABS. Alternatively, or in addition, the CBA registry 504 may have previously interacted with the assurance fund service 508 to obtain carbon leakage protection for individual CBAs, which the CABS 502 service may optionally utilize as part of CABS creation. Once finalized, the CABS may be offered to investors 512 and/or other CABS service users 514 (e.g., issuers, analysts, markets). In some embodiments, investors 512 may interact directly with the CBA registry 504, but may choose to interact with the CABS service 502, e.g., to obtain access to better matched investment vehicles. In some embodiments, the CBA monitoring service 510 may monitor CBAs that participate in a CABS, for example, to detect events that may impact CBA value. For clarity, the CBA monitoring service 510 and the assurance fund service 508 are not explicitly shown as connected directly to the network 506; however, in accordance with at least one embodiment, these services may have such direct access.

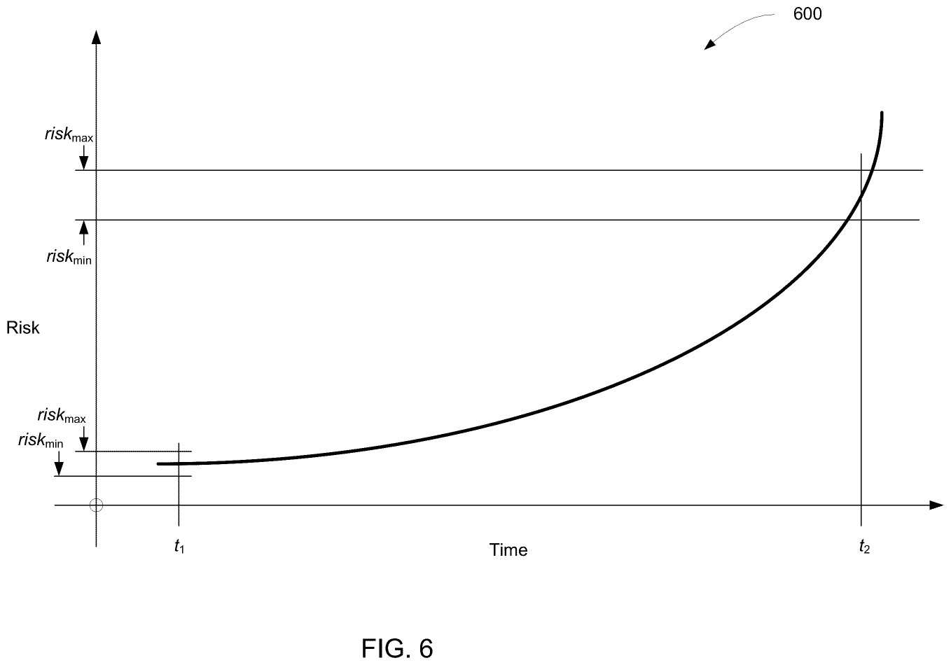

FIG. 6 is a graph 600 illustrating aspects of an example carbon leakage risk curve in accordance with at least one embodiment. The graph 600 shows rising cumulative risk of carbon leakage over time. For clarity, the axes are not to scale. The graph 600 may correspond to an individual CBA or to a pool of CBAs combined into a CABS. When selecting CBAs for a CABS pool, a risk designer may specify minimum and maximum risk parameters (e.g., riskmin and riskmax) at one or more times (e.g., t₁ and t₂) in the intended lifetime of the CABS. The CABS service 502 may use those parameters, and/or other parameters specific to the statistical distribution, to select CBAs that, individually or in combination, generate a risk curve with the desired parameters. In some embodiments, the CABS service 502 may use any suitable statistical and/or optimization technique to select the CBAs, including, without limitation, a manual technique. In accordance with at least one embodiment, multiple goals for the performance of the security may be pursued during CBA selection, for example with respect to yield and default risk of associated debt instruments. As some tradeoffs may be complex, selection rules may be specified to guide and/or determine selection.

At the CBA level, the risk curve may model expected risk over time, for example, based on historical performance for the type of CBA. In accordance with at least one embodiment, the CBA registry 504 may provide model parameters instead of or in addition to risk curve data points. The CABS service 502 may modify model parameters to better suit the needs of its CBA selection process. The shape of risk curves can vary significantly with respect to behavior during early CBA lifetime (e.g., the initial 5%, 10%, 20% of total lifetime) vs late CBA lifetime (e.g., the final 5%, 10%, 20% of total lifetime). Carbon leakage risk may be limited during early CBA lifetime (e.g., less than 0.5%, 1%, 2% of total quantified carbon activity) but may be larger during late CBA lifetime (e.g., less than 5%, 10%, 20% of total quantified carbon activity). Some types of CBA may have low carbon leakage risks across their lifetime, making them particularly useful when selecting pools for CABS goals. For example, CBAs associated with embodied carbon activity in buildings can be relatively leak-stable on a timescale of years, decades or longer. CABS may have market lifetimes that are significantly shorter than underlying CBAs. Accordingly, CBA age may be another factor to consider when selecting CBA pools for CABS, for example, building pools of similar CBA age and/or selecting CBAs to create particular age profiles for the pool such as a Gaussian curve.

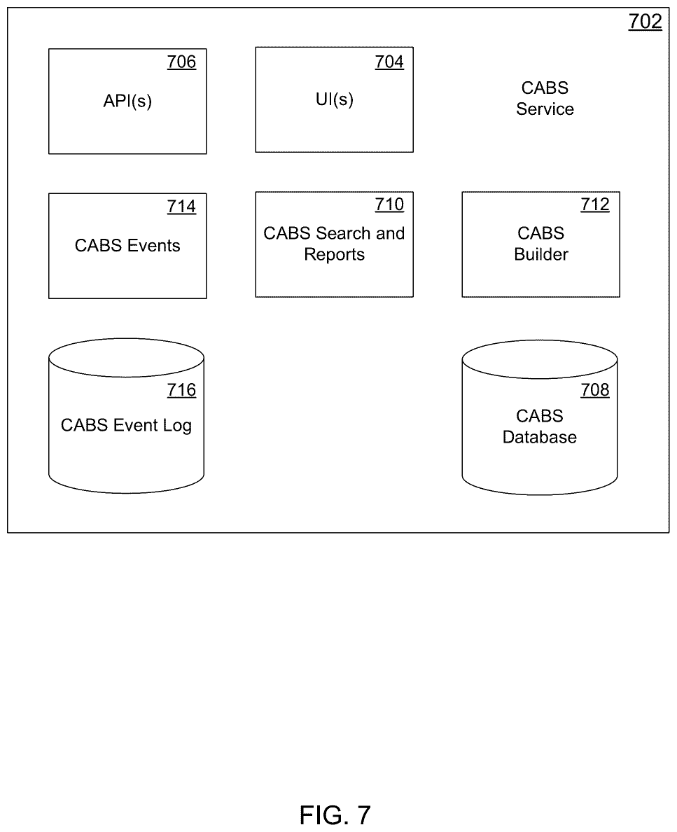

FIG. 7 illustrates aspects of an example CABS service 702 in accordance with at least one embodiment. The CABS service 702 may correspond to the CABS service 502. Users of the CABS service 702 may use one or more user interfaces (UIs) 704 such as a graphical user interface (GUI) and/or one or more application programming interfaces (APIs) 706 to create new CABS as well as to search existing CABS in a CABS database 708 and create reports using a CABS search and reports module 710 with respect to any suitable feature or set of features of existing CABS (to which the user has authorized access).

For example, a user may use an API 706 to open a CABS building session with a CABS builder module 712. The user may further use the API 706 to supply the CABS builder module 712 with the information required to create a CABS. For example, the user may provide a list of CBAs (e.g., CBA IDs from the CBA registry 504) to use to form the CABS. Alternatively, or in addition, the user may provide the CABS builder module 712 with parameters as described elsewhere herein, thereby enabling the CABS builder module 712 to search the CBA registry 504 for suitable candidates for inclusion in the new CABS. Once finalized, the CABS may be made available for investment (may issue), for example, directly to interested investors and/or to more formalized markets. Investors may purchase shares in the CABS and may trade those shares independently of the CABS service 702, although, in accordance with at least one embodiment, the CABS service 702 is the system of record for current ownership of shares in CABS that it issues. Because of the high value that can be involved, the user might be a staff member of the CABS service operator. However, it is possible that that the user is another qualified member, such as a qualified member of a trusted partner.

A CABS events module 714 may handle events related to CABS pre-creation, creation/issue and post-creation, and log the events in a CABS event log 716 for later review and analysis. Pre-creation events may include CABS builder module interaction related to a CABS (whether later issued or not). Post-creation events may include CABS status modifications, events related to assurance policies, events related to ownership lists, and events related to calendar time. Such events may be generated by the CABS service 702 and, in some instances, may result in a notification to interested parties. Alternatively, or in addition, events may be triggered by information submitted via a UI 704 and/or API 706.

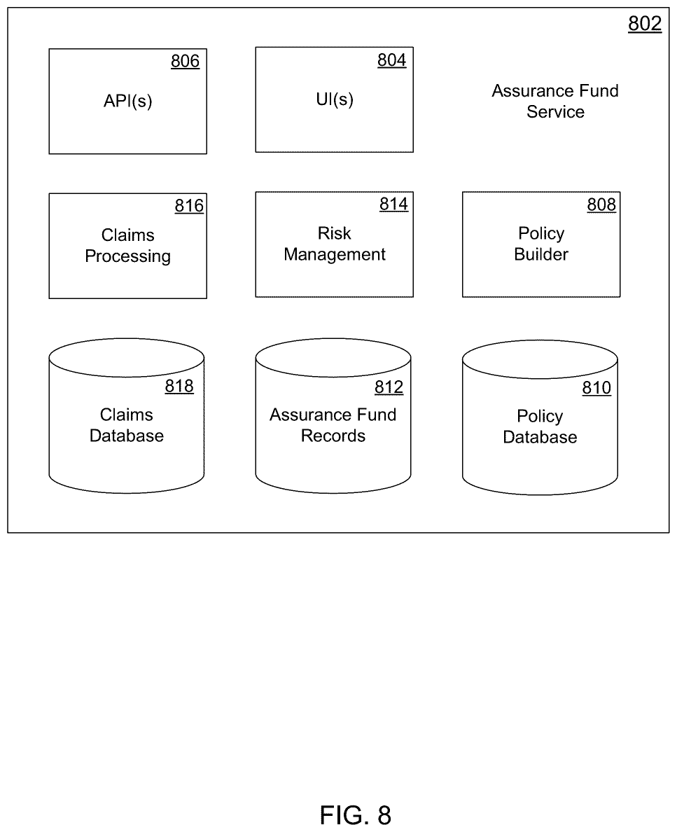

FIG. 8 illustrates aspects of an example assurance fund service 802 (e.g., software as a service) in accordance with at least one embodiment. The assurance fund service 802 may correspond to the assurance fund service 508. Users of the assurance fund service 802 may use one or more user interfaces (UIs) 804 such as a graphical user interface (GUI) and/or one or more application programming interfaces (APIs) 806 to create new assurance policies for CBAs and/or CABS.

For example, a user may use an API 806 to open an assurance policy building session with a policy builder module 808. The user may further use the API 806 to supply the policy builder module 808 with the information required to create an assurance policy. For example, the user may provide a list of one or more CBAs (e.g., CBA IDs from the CBA registry) and the policy builder module 808 may automatically generate assurance policies (e.g., insurance-style policies) with premiums that cover expected value loss due to carbon leakage determined actuarily or otherwise. The policies may be generated (in some examples from templates) for individual CBAs and stored in a policy database 810. Alternatively, or in addition, policies may be generated for the combined set of CBAs and their combined risk curve as described elsewhere herein. The resulting assurance fund may be recorded in an assurance fund records database 812 and managed by a risk management module 814 with respect to one or more goals such as pricing premiums to cover fund payouts, assessing risk for different types of CBA, and/or investing fund balance to achieve a suitable return on investment and fund growth. For example, the risk management module 814 may employ a rules engine enforcing rules based on a user profile or fund profile of suitability and acceptance of risk, which assets to accept or reject, when to invest, and/or when to liquidate. In some embodiments, the risk management module 814 may determine that particular types of CBA are ineligible for assurance fund coverage based on a predetermined risk evaluation and threshold, which may make those assets less attractive to investors. Assurance policies need not compensate for expected carbon leakage in its entirety. For example, a policy may describe an expected carbon leakage floor over an asset or security lifetime and compensate for losses in excess of the floor.

Assurance fund payouts may be authorized after a claims process facilitated by a claims processing module 816, with claims progress and outcomes recorded in a claims database 818. For example, a particular CBA may be associated with embodied carbon activity in a building and the building may experience a disaster resulting in carbon leakage. An obligated reporter (e.g., the registry operator or the building owner) may then use an API 806 or UI 804 to submit a claim to the claims processing module 816 to compensate owners of the particular CBA. A claims process may begin, gather evidence (e.g., via API 806 and/or UI 804), make a determination (e.g., a rules-based assessment in accordance with a previously issued policy), and if appropriate, cause a payout from the assurance fund to compensate the protected CBA.

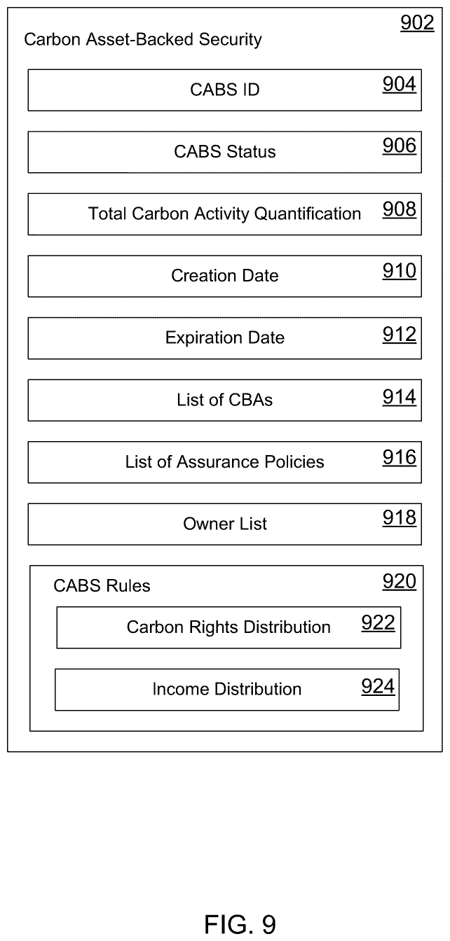

FIG. 9 illustrates aspects of an example CABS data object 902 in accordance with at least one embodiment. The CABS data object 902 may include a CABS identifier (ID) 904 such as a cryptographic identifier and/or a universally unique identifier (UUID) generated as part of the CABS build process. The CABS data object 902 may further include a CABS status 906 of one or more status fields such as a market status (e.g., active, expired, invalid) and a visibility status (e.g., public, private, restricted to a group). A total carbon activity quantification field 908 may characterize the carbon activity associated with the CABS via its pool of CBAs. The CABS data object 902 may include a list of CBAs that are pooled for their carbon rights and associated debt instruments.

The CABS data object 902 may have a creation date 910 which may be prior to or coincide with the date that the CABS issues and become available for investor purchase. An expiration date 912 may differ significantly from the expiration dates of the pool of CBAs. For example, the expiration date 912 of the CABS may be influenced by market expectations around associated debt instruments (e.g., decoupled from the science, although the science may have an impact), while the expiration dates of the CBAs may depend on the underlying type of carbon activity. The CABS data object 902 may include a list of CBAs 914 that are pooled for their carbon rights and associated debt instruments.

The CABS data object 902 may include a list of assurance policies 916 (e.g., a list of policy IDs issued by the assurance fund service). The list may include policies for individual CBAs and/or a single policy for the CABS as a whole. The CABS data object 902 may further include an owner list 918, including shares in the CABS held by individual owners. The owner list may attempt to be authoritative, for example, with the CABS service terms of use requiring updates as to changes in ownership from investors and other users.

Individual CABS may have different shareholder investor distribution rules 920 with respect to carbon rights 922 and/or income 924. The CABS data object may include such rules 920. In accordance with at least one embodiment, such distribution rules may be computer-readable enabling automatic distribution in accordance with the rules. Examples of income distribution rules 924 may include coupon types (e.g., fixed, floating) and payment schedules (e.g., annually, semi-annually).

This disclosure further describes techniques for management of carbon-based assets and securities. CBAs and CABS do not mobilize resources in a vacuum, but instead require interaction with a community of stakeholders including investors, markets, accountants and auditors, and regulators of various kinds. Different stakeholders may have established systems (e.g., computerized systems) for interacting with users and such systems may be of varying levels of sophistication, although the trend has been towards higher levels of technical sophistication. Many systems support at least email and/or PDF forms, but some systems have sophisticated UIs and/or APIs enabling deep access to system functionality and sometimes enabling active querying of the system rather than being passively dependent on notifications. Manual interaction with such systems is possible, for example, using numbers of customer service agents, but often automation is possible and can facilitate scalability and low error rate interoperability.

In accordance with at least one embodiment, external systems may accept a carbon services plugin enabling privileged interaction with the external system and its APIs. Plugins may react quickly to local conditions, signals and/or events to gather relevant local information and/or generate local queries and/or actions. Such plugins are not always possible and with the ever-expanding variety of systems and system versions, it can be beneficial from a development, scalability and/or interoperability point of view to establish a carbon services gateway as a single point of contact for incoming external system messages, whether generated by a carbon services plugin or in raw format from the external system. Such a gateway can include adapters that transform incoming messages into a carbon services canonical form for consistent internal processing, particularly with respect to carbon services business rules. Where replies are required, gateway modules can gather the necessary information and generate a suitable response, or indicate what problems, if any, have arisen.

These techniques may provide effective, efficient, scalable and highly interoperable means for managing carbon-based assets and securities in a heterogeneous computing systems environment. Further details are now described with reference to the figures.

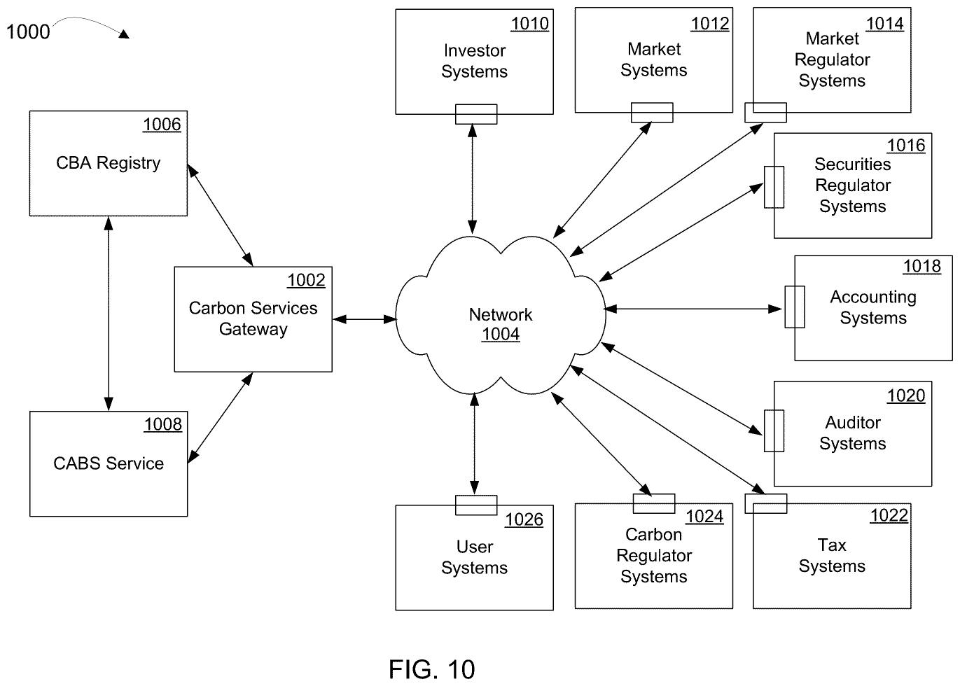

FIG. 10 depicts aspects of an example computer systems architecture 1000 in accordance with at least one embodiment. A variety of external systems 1010-1026 may interact with a carbon services gateway 1002 via a network 1004 (e.g., a data network such as the Internet). In this example, the carbon services gateway 1002 acts as the point of contact with the network for both a CBA registry 1006 and a CABS service 1008, however alternative embodiments are possible. For example, the CBA registry 1006 and the CABS service 1008 may be independently connected to the network 1004, but may not benefit from the functionality provided by the carbon services gateway 1002 when accessed via that route. As another example, the carbon services gateway 1002 may be incorporated into the CABS service 1008, the CBA registry 1006, or both. In this example, each depicted external service may include a carbon services plugin; however, this need not be the case for all embodiments.

Investor systems 1010, which may include systems of internal or private fund investors, may send requests for information about CBAs and CABS, including search and report requests. Such systems may purchase, sell and otherwise trade CBAs and shares in CABS, at times requiring carbon services database updates. Where available, they may request pricing trends and forecasts, as well as details of carbon leakage risk curve models and the like. A carbon service plugin can make this easy for external developers, for example, providing API calls at the level of request_CBA_details (CBA_ID).

Market systems 1012 may provide information on CBA and CABS pricing, trading volume and the like, with market regulator systems 1014 and securities regulator systems 1016 providing significant notifications such as suspended trading in one or more markets and/or carbon service products. Some investors, which may include purchasers of CBAs and/or CABS shares, may be motivated by access to carbon rights, and various accounting systems 1018 are establishing rules around qualified carbon activity quantifications. An accounting system software plugin can facilitate provision of information to the accounting system 1018 that enables the accounting system to apply its rules to the information and accept the carbon services products at face value (or some adjustment thereof). Similarly, an accounting system plugin can facilitate providing information to auditor systems 1020, since they are used to gather information with respect to executive statements for which the auditors provide guarantees, and tax systems 1022.

While largely still under development compared to other regulatory agencies, carbon regulators and carbon regulator systems 1024 are generally sophisticated and can expect high levels of high quality information related to carbon activity quantification, registered CBAs and issued CABS. A software plugin may facilitate approvals and/or certifications as regulation advances. Various other user systems 1026 may interact with the carbon services gateway 1002 via the network 1004 as the point of contact with the network for the CBA registry 1006 and the CABS service 1008.

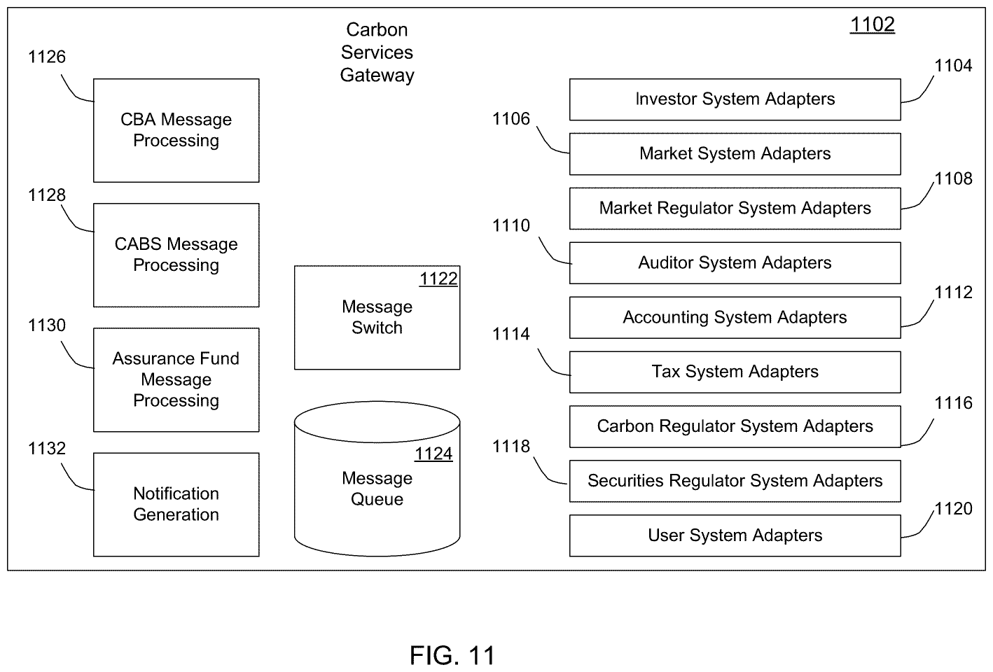

FIG. 11 depicts aspects of an example carbon services gateway 1102 in accordance with at least one embodiment. The carbon services gateway 1102 may correspond to the carbon services gateway 1002. Various adapters 1104-1120 may receive messages from corresponding external systems before transforming the messages into a local canonical form and passing the message to a message switch 1122 for internal distribution. The message switch 1122 may store the message in a persistent message queue 1124 to prevent message loss in case of system outage (e.g., power outage). Transformation of messages may be accomplished with a mapping of data fields from one or more incoming messages to internal canonical message formats. Where more than one incoming message is transformed to a single internal message, state machines or the like may be used to ensure receipt of individual messages in the expected group. Alternatively, or in addition, incoming messages may be analyzed to extract relevant information. For example, email and PDFs with blocks of natural language may be processed with any suitable natural language processing technique, including machine learning (ML), to identify and extract significant information and/or data fields that can be mapped to a canonical internal message.

The message switch 1122 may be a publish-subscribe message propagation software service, with different software modules indicating interest in particular types of internal canonical messages (e.g., subscribing to such messages) and the switch sending copies of incoming messages from the adapters or internal modules to those interested parties (e.g., publishing the messages). The message switch 1122 thereby provides a single point of message distribution control and documentation for local carbon services, which can be helpful for governance and regulatory compliance, as well as enabling scalable expansion to incorporate new external and internal services.

The carbon services gateway 1102 may further include message processing modules 1126-1130, here corresponding to messages applicable to the CBA registry (CBA message processing module 1126), the CABS service (CABS message processing module 1128), and the) assurance fund service (assurance fund message processing module 1130). A single message incoming from one of the adapters 1104-1120 can result in multiple internal messages being sent to the message processing modules 1126-1130, since the incoming message may be of interest to more than one message processing module. The message processing modules 1126-1130 have the ability to apply carbon services business rules such as how particular messages should be handled, what authorization is required, whether a local workflow should be generated involving carbon services staff, and the like. It can be effective and efficient to have such rules defined in a central location such as the carbon services gateway 1102.

Responsive to received messages, the message processing modules 1126-1130 may generate appropriate API calls and/or events at the corresponding carbon services components, and may receive related information in response. Such interactions may be synchronous or asynchronous and may result in new canonical messages being generated, sent to the message switch 1122, and ultimately through one or more of the adapters 1104-1120 to external systems. At times, carbon services components may generate events without external prompting, which may result in a notification generation module 1132 generating notifications to send to the message switch 1122 and ultimately to interested parties. Accordingly, the carbon services gateway may become a hub of carbon services information and functionality in the broader stakeholder community.

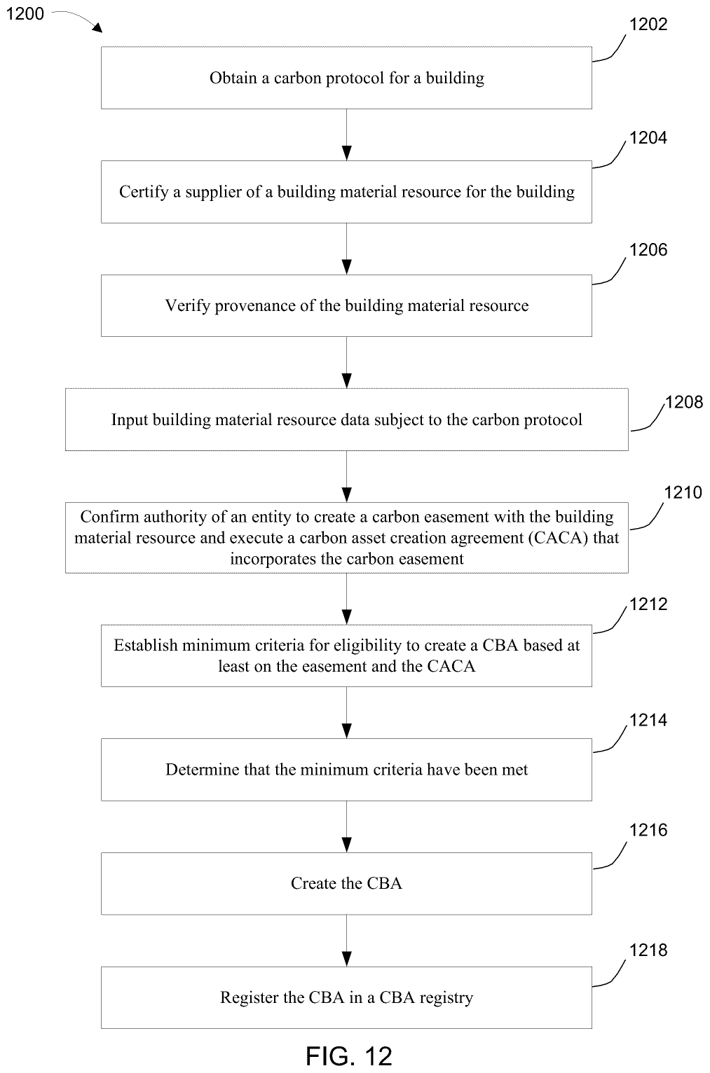

FIG. 12 is a flow diagram of an example process 1200 to create a carbon-based asset. The process 1200 is illustrated as a collection of blocks in a logical flow chart, which represents a sequence of operations that can be implemented in hardware, software, or a combination thereof. In the context of software, the blocks represent computer-executable instructions that, when executed by one or more processors, perform the recited operations. Generally, computer-executable instructions may include routines, programs, objects, components, data structures, and the like that perform particular functions or implement particular abstract data types. The order in which the operations are described is not intended to be construed as a limitation, and any number of the described blocks can be combined in any order and/or in parallel to implement the process. For discussion purposes, the process is described with reference to the computer systems architecture 100 shown in FIG. 1.

At block 1202, the architecture 100 may obtain a carbon protocol for a building. In at least one example, the building is made at least in part with mass timber.

At block 1204, the architecture 100 may certify a supplier of a building material resource for the building. An example of a building material resource is the mass timber.

At block 1206, the architecture 100 may verify provenance of the building material resource. The provenance may include, without limitation, each touchpoint from supplier to delivery vehicle to construction site.

At block 1208, the architecture 100 may input building material resource data subject to the carbon protocol. The building resource data may include identifiers of the building material resource that can, among other things, be used as part of verifying provenance in block 1206.

At block 1210, the architecture 100 may confirm authority of an entity to create a carbon easement with the building material resource and execute a carbon asset creation agreement (CABACA) that incorporates the carbon easement. In some examples, the entity may be a building owner, lessee, or other owner of rights in the carbon asset.

At block 1212, the architecture 100 may establish minimum criteria for eligibility to create a CBA based at least on the easement and the CABACA. In some examples, an audit report may be included with the minimum criteria. The minimum criteria may be established in accordance with manual input or previously determined criteria.

At block 1214, the architecture 100 may determine that the minimum criteria have been met.

At block 1216, the architecture 100 may create the CBA. Creating the CBA may proceed because the minimum criteria have been met.

At block 1218, the architecture 100 may register the CBA in a CBA registry.

It should be understood that the present invention as described above can be implemented in the form of control logic using computer software in a modular or integrated manner. Alternatively, or in addition, embodiments of the invention may be implemented partially or entirely in hardware, for example, with one or more circuits such as electronic circuits, optical circuits, analog circuits, digital circuits, integrated circuits (“IC”, sometimes called a “chip”) including application-specific ICs (“ASICs”) and field-programmable gate arrays (“FPGAs”), and suitable combinations thereof. As will be apparent to one of ordinary skill in the art, notions of computational complexity and computational efficiency may be applied mutatis mutandis to circuits and/or circuitry that implement computations and/or algorithms. Based on the disclosure and teachings provided herein, a person of ordinary skill in the art will know and appreciate other ways and/or methods to implement the present invention using hardware and/or a combination of hardware and software.

Any of the software components, processes or functions described in this application may be implemented as software code to be executed by a processor using any suitable computer language such as, for example, Java, C++ or Perl using, for example, conventional or object-oriented techniques. The software code may be stored as a series of instructions, or commands on a computer readable medium, such as a random-access memory (RAM), a read only memory (ROM), a magnetic medium such as a hard-drive or a floppy disk, or an optical medium such as a CD-ROM. Any such computer readable medium may reside on or within a single computational apparatus, and may be present on or within different computational apparatuses within a system or network.

The use of the terms “a” and “an” and “the” and similar referents in the specification and in the following claims are to be construed to cover both the singular and the plural, unless otherwise indicated herein or clearly contradicted by context. The terms “having,” “including,” “containing” and similar referents in the specification and in the following claims are to be construed as open-ended terms (e.g., meaning “including, but not limited to,”) unless otherwise noted. Recitation of ranges of values herein are merely intended to serve as a shorthand method of referring individually to each separate value inclusively falling within the range, unless otherwise indicated herein, and each separate value is incorporated into the specification as if it were individually recited herein. All methods described herein can be performed in any suitable order unless otherwise indicated herein or clearly contradicted by context. The use of any and all examples, or exemplary language (e.g., “such as”) provided herein, is intended merely to better illuminate embodiments of the invention and does not pose a limitation to the scope of the invention unless otherwise claimed. No language in the specification should be construed as indicating any non-claimed element as essential to each embodiment of the present invention.

Different arrangements of the components depicted in the drawings or described above, as well as components and steps not shown or described are possible. Similarly, some features and subcombinations are useful and may be employed without reference to other features and subcombinations. Embodiments of the invention have been described for illustrative and not restrictive purposes, and alternative embodiments will become apparent to readers of this patent. Accordingly, the present invention is not limited to the embodiments described above or depicted in the drawings, and various embodiments and modifications can be made without departing from the scope of the claims below.

What is claimed is:

1. A method creating a carbon-based asset (CBA), comprising:
obtaining a carbon protocol for a building;
certifying a supplier of a building material resource for the building;
verifying provenance of the building material resource;
inputting building material resource data subject to the carbon protocol;
confirming authority of an entity to create a carbon easement with the building material resource and execute a carbon-based asset creation agreement (CABACA) that incorporates the carbon easement;
establishing minimum criteria for eligibility to create a CBA based at least on the easement and the CABACA;
determining that the minimum criteria have been met;
creating the CBA; and
registering the CBA in a CBA registry.

2. The method of claim 1, further comprising, after creating the CBA:
auditing a build process for the building for compliance with the carbon protocol based on compliance of the input building material resource data and confirmation of the entity authority; and
generating an audit report of the build process.

3. The method of claim 2, further comprising:
obtaining multiple carbon protocols for the building; and
verifying provenance of the building material resources for the one or more suppliers,
wherein confirming authority of the entity to create the carbon easement is for a carbon easement with the building material resources; and
the auditing is carried out for compliance with the multiple carbon protocols.

4. The method of claim 3, wherein the building material resource data includes carbon activity quantifications associated with individual types of building material resources.

5. The method of claim 1, wherein:
verifying provenance of the building material resource includes maintaining multiple verification touchpoints between the supplier and the site for constructing the building; and
confirming the building material resources at each of the verification touchpoints.

6. The method of claim 1, wherein the carbon protocol includes one or more technical choices with respect to factors to estimate or determine carbon activity quantification.

7. The method of claim 6, wherein the building material resource data includes carbon activity quantifications associated with individual types of building material resources.

8. One or more computer-readable media storing executable instructions that, when executed by one or more processors, cause the one or more processors to perform operations of a method creating a marketable carbon-based asset (CBA) security, the operations comprising:
opening a CBA building session;
receiving input of a carbon-based asset creation agreement (CABACA) for creation of a marketable CBA security, a specification for an easement, and an audit report to create the CBA;
assessing the CABACA, easement, and audit report against a carbon protocol;
creating the carbon-based asset for a building material passing the assessment; and
creating a marketable CBA security from the carbon-based asset.

9. The one or more computer-readable media of claim 8, wherein the operations further comprise:
adding the CBA to a CBA registry of CBAs,
wherein the CBA registry is a system of record for ownership of the CBAs recorded therein.

10. The one or more computer-readable media of claim 9, wherein the operations further comprise:
receiving a token that identifies a new owner of the CBA; and
in response to receiving the token, changing the ownership record in the CBA registry to reflect the new owner of the CBA.

11. The one or more computer-readable media of claim 8,
wherein the CBA is implemented as a data object that includes a carbon activity quantification of carbon activity associated with a property underlying the CBA, a market status of the CBA, an identifier of the property, a chain of title to the CBA, recipients of carbon rights in the CBA, the audit report, a recorded easement to the carbon activity, and the CABACA.

12. The one or more computer-readable media of claim 8, wherein the security is a debt instrument.

13. The one or more computer-readable media of claim 12, wherein the operations further comprise:
receiving input of an event impacting carbon activity associated with a property underlying the CBA; and
triggering a process to compensate for a loss incurred due to the carbon activity impact,
wherein the CBA is associated with carbon activity having a risk curve that reflects a market impact due to potential changes in carbon activity in the property.

14. The one or more computer-readable media of claim 13, wherein the operations further comprise:
providing information identifying one or more CBAs from the CBA registry; and
automatically generating assurance policies with premiums that cover expected value loss due to carbon leakage.

15. The one or more computer-readable media of claim 14, wherein the operations further comprise:
employing a rules engine that enforces rules based on a user profile or investment fund profile of suitability and acceptance of risk, which assets to accept or reject, when to invest, and/or when to liquidate creating an investing fund balance to achieve a threshold return on investment or fund growth.

16. The one or more computer-readable media of claim 8, wherein the security includes a carbon right via pooled CBAs.

17. A system to create a marketable carbon-based asset (CBA) security, comprising:
one or more processors; and
one or more computer-readable media storing executable instructions that, when executed by one or more processors, cause the one or more processors to perform operations comprising:
opening a CBA building session;
receiving input of a carbon-based asset creation agreement (CABACA) for creation of a marketable CBA security, a specification for an easement, and an audit report to create the CBA;
assessing the CABACA, easement, and audit report against a carbon protocol;
creating the carbon-based asset for a building material passing the assessment; and
creating a marketable CBA security from the carbon-based asset.

18. The system of claim 17, wherein the operations further comprise:
adding the CBA to a CBA registry of CBAs, wherein the CBA registry is a system of record for ownership of the CBAs recorded therein;
receiving a token that identifies a new owner of the CBA; and
in response to receiving the token, changing the ownership record in the CBA registry to reflect the new owner of the CBA.

19. The system of claim 17,
wherein the CBA is implemented as a data object that includes a carbon activity quantification of carbon activity associated with a property underlying the CBA, a market status of the CBA, an identifier of the property, a chain of title to the CBA, recipients of carbon rights in the CBA, the audit report, a recorded easement to the carbon activity, and the CABACA.

20. The system of claim 17, wherein the security is a debt instrument and the operations further comprise:
receiving input of an event impacting carbon activity associated with a property underlying the CBA; and
triggering a process to compensate for a loss incurred due to the carbon activity impact,
wherein the CBA is associated with carbon activity having a risk curve that reflects a market impact due to potential changes in carbon activity in the property.
